(19) United States
(12) Patent Application Publication
(10) Pub. No.: US 2010/0231776 A1
(43) Pub. Date: Sep. 16, 2010

(54) PERSONAL PROTECTION DEVICE WITH WIRELESS AUDIO-VISUAL TRANSMISSION

(76) Inventors: Wen-Tsung Li, Pingtung Hsien (TW); Yen-Hung Lay, Pingtung Hsien (TW)

Correspondence Address: RABIN & Berdo, PC, 1101 14TH STREET, NW, SUITE 500, WASHINGTON, DC, 20005, US

(21) Appl. No.: 12/403,676

(22) Filed: Mar. 13, 2009

(51) Int. Cl. H04N 5/222; F41B 15/04

(52) U.S. Cl. 348/333.01; 361/232; 348/E05.024

(57) ABSTRACT

A personal protection device with wireless video and audio transmission capability includes a housing mounted with a lighting element, a camera, an electric shock electrode set, a display panel, a key set, a mode switch, an electric shock activating button and a circuit module. In use, a user on patrol can use the camera and the microphone to record video and audio data in real time, and activate the electric shock electrode to produce a high voltage for self-defense while confronting attacks. The recorded video and audio data is wirelessly transmitted to a remote monitoring center in real time.

### BACKGROUND OF THE INVENTION

1. Field of the Invention

The present invention relates to a personal protection device with wireless audio-visual transmission capability, and more particularly to a portable device that can transmit video and audio data wirelessly to a remote receiver in real time.

2. Description of Related Art

Security guards and policemen may use a normal portable lighting device such as a flashlight for inspecting surroundings in the dark when on patrol. Monitoring cameras may be additionally provided and mounted at different locations to watch for abnormal situations.

However, the present portable lighting device only acts as an illumination apparatus without any active defending or recording abilities. Once emergencies or abnormal events occur, people only rely on their memory and often cannot describe or report the real situations in detail at that time accurately. Even video data captured by the monitoring cameras could be used as evidence. Also, video data may still be limited to particular positions. The fix-position mounted cameras may also be destroyed or purposefully avoided so not capable of recording some significant events.

To overcome the shortcoming, the present invention provides a personal protection device with wireless audio-visual transmission capability to mitigate or obviate the aforementioned problem.

### SUMMARY OF THE INVENTION

The main objective of the invention is to provide a personal protection device integrated with a wireless audio-visual transmission capability allowing a person to activate an electric shock function for self-defense and to record any sudden events and transmit the recorded video and audio data to a remote monitoring center wirelessly.

To achieve the objective, the personal protection device in accordance with the present invention has a housing mounted with a lighting element, a camera, an electric shock electrode set, a display panel, a key set, a mode switch, an electric shock activating button and a circuit module. In use, a user on patrol can use the camera and the microphone to record video and audio data. The electric shock electrode set can be activated to generate a high voltage for self-defense while confronting attacks. The recorded video and audio data can be wirelessly transmitted to a remote monitoring center in real time.

Therefore, when the user is patrolling at night, the device can be used to record video information anywhere without location limitations. Further, any sudden event occurring during the patrol can be objectively and truly recorded and then transferred to a remote monitor center or provisionally stored in the device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a personal protection device in accordance with the present invention; and

FIG. 2 is a functional block diagram of a control circuit in the portable light and personal security device of FIG. 1.

### DETAILED DESCRIPTION OF THE PREFERRED EMBODIMENT

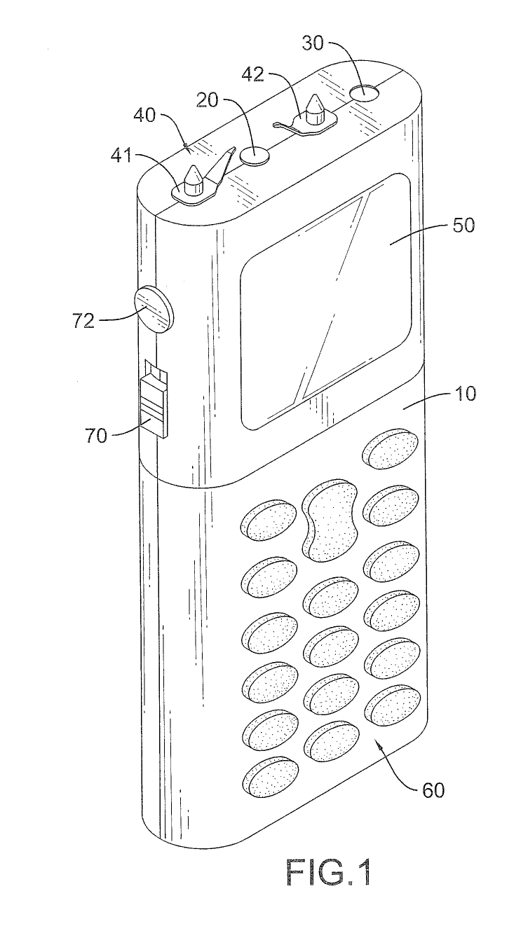

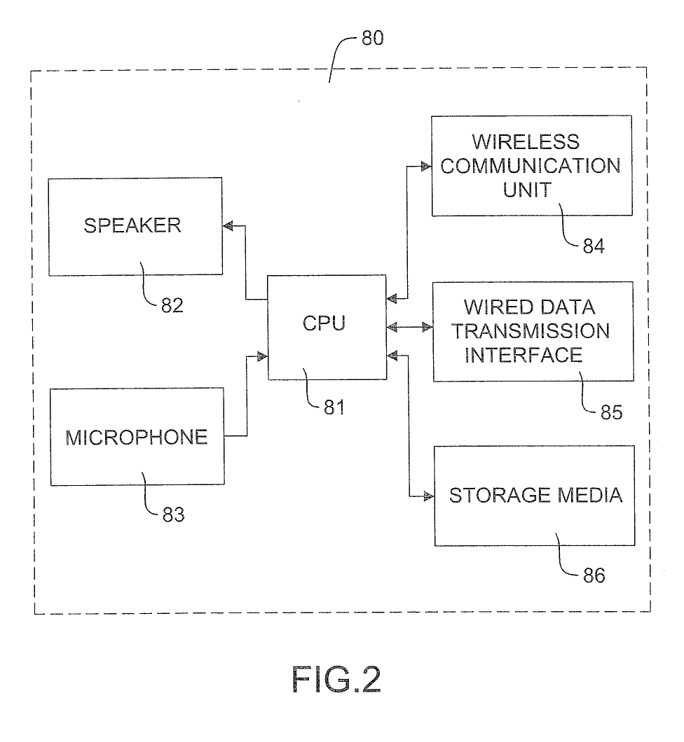

With reference to FIGS. 1 and 2, a personal protection device with wireless audio-visual transmission capability in accordance with the present invention comprises a housing 10, a lighting element 20, a camera 30, an electric shock electrode set 40, a display panel 50, a key set 60, a mode switch 70, an electric shock activating button 72 and a circuit module 80.

The housing 10 has a front surface, a top surface and a side surface.

The lighting element 20 is mounted on the housing 10, preferably on the top surface of the housing 10 and may be a light emitting diode (LED) or a bulb.

The camera 30 is mounted on the housing 10, preferably on the top surface of the housing 10 to capture and record images.

The electric shock electrode set 40 comprises a first electrode 41 and a second electrode 42 mounted on the housing 10 and separated from each other by a small distance to pass a high voltage through the air between the electrodes when they are activated.

The display panel 50 is mounted on the housing 10, preferably on the front surface of the housing 10 and may be a monochrome or color LCD panel to show video data and operating messages.

The key set 60 is mounted on the housing 10, preferably on the front surface of the housing 10 and may comprise a recording key, a lighting key, a dial key, an answer key, number keys and the like.

The mode switch 70 is mounted on the housing 10, preferably provided on the side surface of the housing 10 for switching to either a normal mode or an electric shock mode.

The electric shock activating button 72 is mounted on the housing 10, preferably on the side surface of the housing 10. When the button 72 is activated, the electric shock electrode set 40 produces a high voltage.

The circuit module 80 is held in the housing 10 and electrically connected to the lighting element 20, the camera 30, the electric shock electrode set 40, the display panel 50, the key set 60 and the mode switch 70.

Since the lighting element 20, the camera 30 and the electric shock electrode set 40 are all located on the same surface of the housing 10, the lighting element 20 can provide supplementary light when the camera 30 is recording images in dark environment to obtain clear video information.

As shown in FIG. 2, in addition to control the illumination and electric shock functions, the circuit module 80 allows the device of the present invention to act as a telecommunication tool like a cell phone. The circuit module 80 comprises a central processing unit (CPU) 81, a speaker 82, a microphone 83, a wireless communication unit 84, a wired data transmission interface 85 and a storage media 86.

The CPU 81 acts as a control unit and processes video and audio data and other necessary control signals, for example, recorded image data generated by the camera 30 and remote audio-visual data received by the wireless communication unit 84 are input to and processed by the CPU 81.

The speaker 82 is connected to the CPU 81 and outputs processed audio data.

The microphone 83 is connected to the CPU 81 to record acoustic information of surroundings and spoken voice when the user is telecommunicating with a remote person. The recorded audio data are then transmitted to the CPU 81.

The wireless communication unit 84 is connected to the CPU 81 and performs bi-directional data transmission. The wireless communication unit 84 comprises an antenna element to transmit and receive wireless signals.

The wired data transmission interface 85 is connected to the CPU 81 and is connected to a data cable. For example, the wired data transmission interface 85 may be a USB interface to which a USB cable can be connected.

The storage media 86 is connected to the CPU 81 and stores audio-visual data and a communication list. The audio-visual data recorded by the camera 30 and the microphone 83 can be stored in the storage media 86 as backup information or further transferred to other external disk.

In use, the user can select the normal mode or the electric shock mode to be operated by controlling the mode switch 70. The electric shock electrode set 40 will generate a high voltage only if the electric shock activating button 72 is triggered in the electric shock mode for self-defense. If the mode switch 70 is switched to the normal mode, the electric shock activating button 72 is disabled automatically to avoid accidental activation.

When the user is on patrol, the lighting element 20 associated with the camera 30 can be used to capture and record surrounding images without blind spots. The recorded data can be stored in the storage media 86 or transmitted to a remote monitoring center immediately and wirelessly through the wireless communication unit 84.

Further, with the wireless communication unit 84, the device can be used as a telecommunication tool that allows the user to dial a phone number using the number keys of the key set 60 and watch images on the display panel 80 transmitted from the remote person.

In conclusion, the present invention further integrates with personal security and audio-visual data transmission capabilities. When the user confronts urgent situations or attack, the electric shock function can be activated for self-defense. With the audio-visual is being recorded, the video data are not limited to fixed locations so the problem of blind spots is resolved.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A personal protection device with wireless video and audio transmission capability comprising:
a housing having a top surface, a front surface and a side surface;
a lighting element mounted on the housing and providing illumination light;
a camera mounted on the housing to capture and record images;
an electric shock electrode set comprising a first electrode and a second electrode both being mounted on the housing and separating from each other by a small distance;
a display panel mounted on the housing to show video data and operating messages;
a key set mounted on the housing;
a mode switch mounted on the housing for selecting either a normal mode or an electric mode; and
an electric shock activating button mounted on the housing to control the electric shock electrode set to produce a high voltage;
a circuit module mounted in the housing, electrically connected to the lighting element, the camera, the electric shock electrode set, the display panel, the key set, the mode switch and the electric shock activating button and having wireless telecommunication abilities to perform wireless video and audio transmission.

2. The personal protection device as claimed in claim 1, wherein the circuit module comprises:
a central processing unit (CPU) as a control unit;
a speaker connected to the CPU for outputting processed audio data;
a microphone connected to the CPU to record acoustic information of surroundings and spoken voice;
a wireless communication unit connected to the CPU and performing bidirectional data transmission;
a wired data transmission interface connected to the CPU for linking to an external device via a cable; and
a storage media connected to the CPU and storing recorded video and audio data.

3. The personal protection device as claimed in claim 1, wherein the lighting element, the camera and the electric shock electrode set are mounted on the top surface of the housing;
the display panel and the key set are mounted on the front surface of the housing; and
the mode switch and the electric shock activating bottom are mounted on the side surface of the housing.

4. The personal protection device as claimed in claim 2, wherein
the lighting element, the camera and the electric shock electrode set are mounted on the top surface of the housing;
the display panel and the key set are mounted on the front surface of the housing; and
the mode switch and the electric shock activating bottom are mounted on the side surface of the housing.

5. The personal protection device as claimed in claim 3, wherein the key set comprises a recording key, a lighting key, a dial key, an answer key and number keys.

6. The personal protection device as claimed in claim 4, wherein the key set comprises a recording key, a lighting key, a dial key, an answer key and number keys.
